(19) United States
(12) Patent Application Publication
(10) Pub. No.: US 2007/0156455 A1
(43) Pub. Date: Jul. 5, 2007

(54) System and Method for Providing a Consumer Healthcare Guide

(76) Inventors: Michael David Tarino, St. Paul, MN (US); Matthew T. Wiandt, Minnetonka, MN (US); Tomas David Valdivia, Edina, MN (US); Adam Bock, Eagan, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/565,154

(22) Filed: Nov. 30, 2006

Related U.S. Application Data
(60) Provisional application No. 60/741,265, filed on Dec. 1, 2005.

(51) Int. Cl. G06Q 10/00; G06F 17/30

(52) U.S. Cl. 705/2; 707/3

(57) ABSTRACT

A system and method for providing a consumer healthcare guide receive a set of search criteria and retrieve one or more health-related listings based on the set of search criteria. The health-related listings may include healthcare quality data and/or consumer cost data, which may include provider listings and/or facility listings. The provider listings may include a consumer cost rating based upon provider costs associated with a selected healthcare product or service. The facility listings may include a consumer cost rating based upon facility charges associated with a selected healthcare product or service. The consumer guide may also provide quality data, such as a healthcare quality rating corresponding to a quality score based on predetermined criteria. The consumer guide further may provide cost and/or quality information on a variety of aspects of healthcare including, for example, hospitals and other facilities, doctors and other providers, pharmaceuticals, and health insurance plans.

### CROSS-REFERENCE TO RELATED APPLICATION

The present invention claims priority to U.S. Provisional Patent Application No. 60/741,265, filed on Dec. 1, 2005, which is herein incorporated by reference in its entirety.

### FIELD OF THE INVENTION

The present invention relates to providing consumers with a way to make better-informed healthcare choices by providing a method and system for providing a consumer healthcare guide.

### BACKGROUND

The selection of healthcare services, products and providers may be difficult for consumers for a number of reasons. Often, meaningful healthcare information is unavailable to consumers. For example, health-related costs to the consumer in any given market for any given procedure may vary, and the consumer may not have access to the current costs they may incur for receiving a health-related service or product. In addition, the quality of care may vary within any given market. For example, various providers may have differing levels of experience or skill for a given procedure, product or service, but this information typically is not available to consumers. As a result, consumers often make choices concerning their healthcare products, service and/or providers without the benefit of accurate cost and quality information.

### SUMMARY

A system and method for providing a consumer healthcare guide enables consumers to make better-informed decisions concerning health-related products, services and/or procedures by generating a consumer healthcare guide that provides quality and/or cost information to the consumer. The guide may allow a consumer to understand their cost liability when choosing to receive health-related products, procedures or services. The guide also may provide consumers with increased transparency in relative cost and quality in the healthcare marketplace, which enables the consumer to make better-informed healthcare decisions.

The system and method described above may offer a consumer healthcare guide that provides the cost to the consumer of a selected healthcare procedure, product or service instead of the total cost of the procedure, product or service (portions of which may be reimbursed by an insurance company, reduced through provider contracts, subject to co-payment limitations, etc., and are therefore not paid by the consumer). The guide may also or alternatively provide relative cost information in the form of cost rating data or other relative cost data to indicate the relative expense of a given procedure, product or service provided by various providers or facilities. Thus, the consumer can select a provider based upon the relative cost of that provider in comparison to other providers of the same procedure, product, or service.

Additionally or alternatively, quality information provided the consumer guide may inform the consumer as to the quality of the facility or provider to enable the consumer to make a better-informed facility and/or provider selection based on the quality of service desired. The quality information may be provided in the form of quality rating data or other relative quality data to indicate the relative quality of a given procedure, product or service provided by various providers or facilities. Thus, the consumer can select a provider based upon the relative quality of that provider in comparison to other providers of the same procedure, product, or service.

In systems in which both cost data and quality data are provided, the guide enables consumers to weigh cost and quality information in selecting a service, procedure, product, facility and/or provider to identify the best quality level at their desired cost level.

A method for providing a consumer healthcare guide includes receiving search criteria, and retrieving health-related listings based on the search criteria, where at least one of the listings includes consumer cost data or healthcare quality data associated with the health-related listing. The consumer cost data may include a dollar value, a range of dollar values, or relative cost information for one or more providers and/or facilities. The healthcare quality data may include healthcare quality data relating to one or more providers and/or facilities and may be calculated based upon, for example, an analysis of historical claim data received from the provider or facility.

A system for providing a consumer healthcare guide includes data storage for storing health-related data, and a processor for receiving search criteria and retrieving health-related listings based on the search criteria, wherein at least one listing includes consumer cost data and/or healthcare quality data that is associated with the health-related listing. The consumer cost data may include a dollar value, a range of dollar values, or relative cost information for one or more providers and/or facilities. The healthcare quality data may include healthcare quality data relating to one or more providers and/or facilities and may be calculated based upon, for example, an analysis of historical claim data received from the provider or facility.

The consumer healthcare guide provided by the system and method described above may be, for example, a healthcare facilities consumer guide that provides cost and/or quality data relating to hospitals and other healthcare facilities. In another example, a provider consumer guide is provided that includes cost and/or quality data relating to providers. In a further example, a combined facilities and provider consumer guide is provided that includes cost and/or quality data related to facilities and providers. In a further example, the consumer guide provides cost and/or quality information on a variety of aspects of healthcare including, for example, hospitals and other facilities, doctors and other providers, pharmaceuticals, and health insurance plans.

Moreover, the consumer healthcare guide may be associated with other healthcare services. For example, the consumer guide may be provided on a web interface and may be associated with “web-visits”, which allow consumers to have low cost virtual visits with healthcare providers for services such as non-complex clinical questions and prescription renewals.

The consumer healthcare guide may be administered by a health insurance company, for example, which may add incentives for consumers to choose lower cost providers for higher cost services. For example, a health insurance company may allow the consumer to pay lower co-insurance for visits to selected high quality low-cost providers. Providing such incentives may further promote healthcare services to lower their costs, for example, in order to be categorized as high quality and low-cost.

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1A is a diagram of an exemplary system for providing a consumer healthcare guide.

FIG. 1B is a flowchart of a method for providing a consumer healthcare guide.

FIG. 2 depicts an exemplary web interface configured for user access.

FIG. 2A depicts an exemplary web interface configured to provide user access to doctors and hospitals.

FIG. 3 depicts an exemplary web interface that may be displayed when a consumer selects the “Find a Doctor” link of FIG. 2.

FIG. 4 depicts an exemplary web interface that provides an exemplary listing of doctor specialties that may be selected by the user as search criteria.

FIGS. 5-5B depict exemplary web interfaces displaying an exemplary listing of results for a doctor search and associated details.

FIG. 6 depicts an exemplary web interface enabling a user to search for hospitals within a defined geographic area based upon a selected procedure or condition to view hospital quality and cost for the selected procedure or condition.

FIG. 7 depicts an exemplary web interface providing exemplary cost and quality rating information for a selected hospital facility.

FIG. 8 depicts an exemplary web interface providing exemplary results of a search for facilities for a selected procedure, including quality rating data, cost rating data, and specific cost ranges.

FIG. 9 depicts an exemplary web interface having exemplary procedure specific information displayed when a user selects a link such as “What's included in this cost?”, depicted in FIG. 8.

### DETAILED DESCRIPTION

A system and method for providing a consumer healthcare guide will now be described with reference to the accompanying drawings.

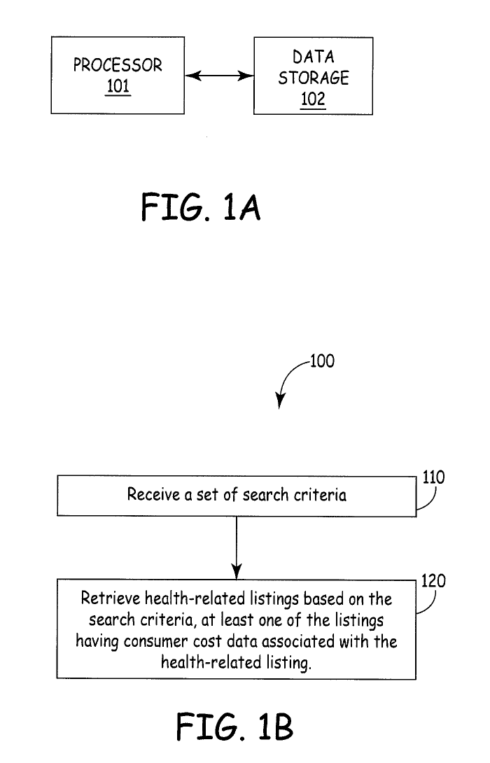

FIG. 1A is a diagram of an exemplary system for providing a consumer healthcare guide. The exemplary system includes a processor 101 and data storage 102. The processor 101 is configured to receive search criteria, and retrieve one or more health-related listings based on the search criteria, in which the health-related listing includes associated consumer cost data. Data storage 102 is configured for storing health-related data and is communicatively coupled to the processor 101 to enable the processor to retrieve health-related data. Health-related data may include provider or facility listings, and the consumer cost data may be provided as a cost rating. In addition, quality data related to provider or facility listings may be included in the health-related data retrieved from data storage 102, and may be provided as health-related lsting quality data, for example, in the form of a quality rating. Furthermore, a graphical user interface or other user interface may be provided that is communicatively with processor 101 and/or storage 102 for facilitating user access to the cost and/or quality information associated with the health-related data.

FIG. 1B is a flowchart of a method 100 for providing a consumer healthcare guide. Method 100 includes receiving 110 search criteria, and retrieving 120 one or more health-related listings based on the search criteria, where at least one of the listings includes associated consumer cost. Search criteria may be entered by a consumer, such as a member of an insurance plan, and may include search data such as the type of health-related data sought, e.g., provider, facility, medical device, prescription, and area of search, e.g., city, state, radius.

In a further example, health-related data may be provided that includes quality data as an alternative to or in addition to associated consumer cost data.

Search criteria may be entered by a user, wherein the user selects, for example, a specific geographical location and specific type of service or procedure desired. In this example, the user may select to view data concerning all facilities in the specified geographic area that provide the desired service or procedure, all healthcare providers in the selected area that provide the desired service or procedure, or both.

In response to a search request entered by the user such as described above, the processor 101 generates a graphic user interface to display a consumer healthcare guide including provider rating data and/or facility rating data. Providers may include doctors and other providers of health-related services. Facilities include hospitals, clinics and other facilities at which health-related services are provided. The provider rating data and facility rating data may include relative rating information concerning the cost and/or quality for each provider and/or facility. Other data also may be displayed as desired by the implementers of the system and/or the user.

Cost and quality information associated with a consumer healthcare guide may be displayed, for example, as a discrete cost rating and quality rating for each provider and/or facility meeting the search criteria input by the user. For example, a cost rating may be a “$” rating, e.g., one $ as the lowest rating and three $$$ as the highest rating, and a quality rating may be a star rating “★”, e.g., one star ★ as the lowest rating and three stars ★★★ as the highest rating. Cost rating information may also include relative cost, e.g., a cost percentage difference from the marketplace, and/or average costs. In addition, a consumer reviewing quality and cost data related to health-related data may also review the underlying measures driving quality and cost ratings. For the consumer healthcare guide, quality and cost data may be provided about health-related services, products, facilities, and providers, for a number of inpatient and outpatient procedures and/or medical conditions. However, it should be understood that cost and quality information may be represented or displayed in any way, and that the “$” rating and star rating are exemplary implementations of communicating cost and quality ranking. Furthermore, additional data relevant to a consumer's healthcare choice may be presented to a user in addition to or as an alternative to cost and quality data.

According to certain implementations, cost and quality rating data may be calculated based on historical claim data for each provider and facility. For example, cost rating data may be based upon charges submitted in historical claim data related to procedure-based data, and may be presented to the consumer as ratings corresponding to high, low and average charges.

In a particular implementation, one method for generating cost rating data includes determining the relative cost a consumer may incur for a procedure at a facility includes: (1) estimating the average billed charges, i.e., the total amount billed by a facility for a healthcare service with no discounts reflected, for a procedure at a facility level. Medicare and commercial facility charge data may be gathered to estimate the average billed charges for each facility performing the procedure, for example. In some implementations, data may be patient-level data, and for inpatient cases, information such as average length of stay may be included in the estimated average billed charges. Inpatient averages may be “severity-adjusted”, described below, to account for case mix and severity. For example, for certain types of acute conditions, larger facilities may have a longer average length of stay and higher average charge per stay compared with other facilities that do not have the capacity to treat as many acute patients. Furthermore, the more acute patients a facility treats, the higher the complication rate and therefore average billed charge. In addition, patients who die early in their stay or who are transferred also needs to be accounted for in order to accurately estimate average billed charges for a procedure.

Upon estimating the average billed charges, (2) application of network payment methodologies (such as fee schedules) to billed charges enables estimating the average relative cost to a consumer for a procedure. In some instances, networks may provide a discount across procedures, which may be taken into account when determining the average cost to a consumer. Subsequently, (3) grouping of the facilities within a market into cost tiers, e.g., by geography and/or zip code, for each procedure allows a consumer to compare medical facilities at the procedure and/or diagnosis level. For example, the facilities may be grouped into three tiers within each market. Grouping may be accomplished using a cluster analysis, which maximizes differences between each tier and minimizes the differences within a tier. Tiers may then be evaluated to confirm that the tiers reflect meaningful differences.

However, for some procedures, such as outpatient treatment of diabetes for one year, estimating and applying network payment methodologies may be more complex because a variety of procedures such as office visits, eye exams, blood tests, and drugs may need to be accounted for. As a result, estimating billed amounts and applying network payment methodologies may result in figures with a degree of error. Therefore providing an average relative cost to the consumer, as opposed to a specific cost, may provide the consumer with an idea of the annual cost of treatment for diabetes when the exact cost may not accurately be calculated.

It will be understood that determining the relative cost to a consumer for a procedure in relation to a provider, medical equipment, and/or pharmaceutical, for example, may be performed in a similar manner as the above-described average cost to the consumer for treatment at a facility. In addition, other factors may also be considered when determining average cost to consumer for health-related services and or products. For example, for medical equipment such as a motorized wheelchair, the cost data may provide the consumer with an average cost for a variety of motorized wheelchairs, where factors such as shipping charges and electricity consumption may be considered. In another example, pharmacy cost data may be provided to the consumer that provides prescription costs to the consumer for a variety of pharmacies, where factors such as distance from the consumer and/or shipping are considered.

Quality data, e.g., quality rating data, may be generated from historical claim data for providers and facilities, including procedure-based data that is gathered for a selected procedure and/or condition. For example, information for a provider or medical facility related to a healthcare procedure and/or condition, such as a procedure's average charges, length of stay for the procedure, and number of procedures performed, may be gathered, and a quality score for the provider or facility generated. In another example, information for pharmaceuticals for treating a condition such as side effects, complication rates, and treatment effectiveness may be factored in a quality rating. In another implementation, information for medical equipment such as ease of use, maintenance requirements, and replaceable parts may be factored in a quality rating.

In another example, quality data may be generated for a facility by considering factors such as the number of patients seen per year, mortality rates, failure to rescue, major complication rates, available technology, e.g. availability of electronic prescribing systems, and intensive care unit staffing. In some instances the factors may be weighted depending of the importance of the factor. For example, the number of patients seen per year may be a strong indicator of quality because facilities that perform a particular treatment or procedure more may achieve better results compared to those facilities with less experience, and therefore may be weighted more than other factors. Major complication rates, i.e., the percentage of patients who developed problems while being treated, may be a strong indicator of the quality of a medical facility's care, and facilities with the fewest problems during treatment may be considered better, and thus major complication rates may be weighted more than other factors. Failure to rescue, i.e. those patients receiving the particular procedure that became very ill, may be considered less of an indicator because some facilities treat more seriously ill patients than others, and may be weighted less than other factors.

For both quality and cost data, the factors considered in generating the data may need to be “severity-adjusted” from facility to facility or provider-to-provider. For example, weighted national averages for a given condition may be applied to some factors in order to standardize the factor score for specific facilities. Otherwise, facilities caring for sicker patients that die, become very ill, or experience major complications may be penalized.

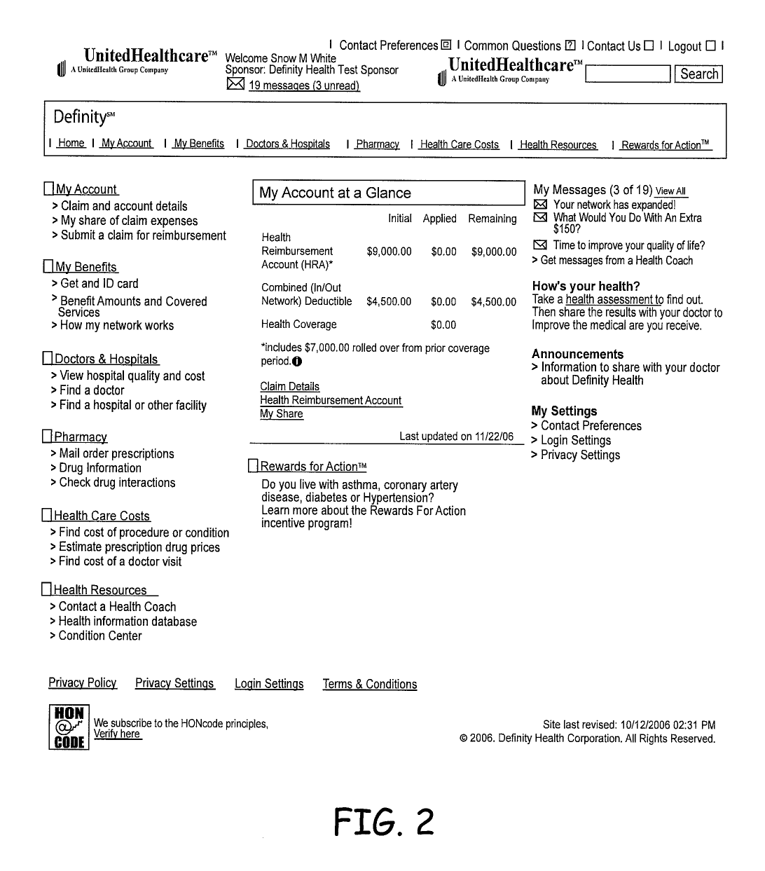

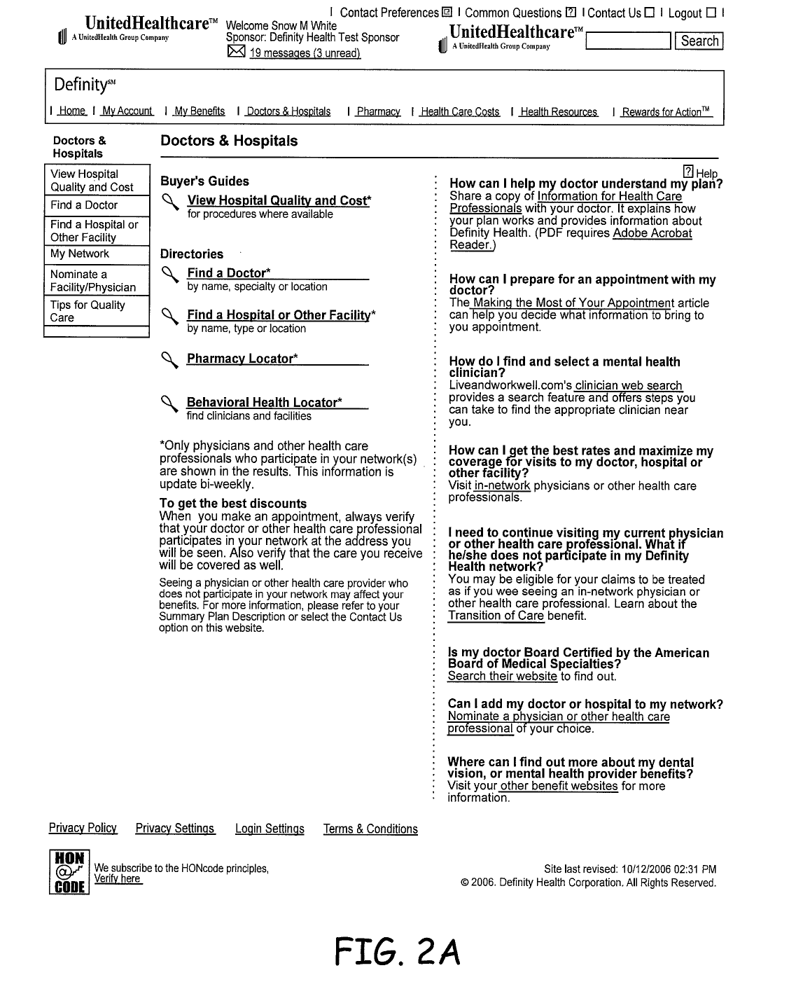

Consumer healthcare guides may be provided in a variety of mediums including on a graphical user interface (GUI), such as a web interface, and on paper. In exemplary configurations, depicted in FIGS. 2-9, consumer healthcare guides are provided on a web interface. Data has been redacted as appropriate to protect the privacy interests of providers and facilities.

FIG. 2 depicts a web interface configured for consumer access. For example, the consumer may access the web interface of FIG. 2 by verifying that the consumer is a member of the healthcare plan that supports the web interface. The consumer may select from a variety of links on the web interface of FIG. 2, including links related to the consumer's account and benefits, links for providing searching for facility and/or provider quality and cost data, links for reviewing procedure pricing data, and links for reviewing health resources. Providing a web interface such as the one depicted in FIG. 2 enables an insurance company, for example, to align their healthcare support services while enabling easy user access.

For example, when a consumer is in need of healthcare, they may review quality and cost data related to providers in the consumer's proximate area by selecting the “find a doctor” link. This may allow for a consumer's provider choice to be at least partially based on information provided on the web interface.

FIG. 2A providers an exemplary display of a selection screen by which a user may select from various search capabilities, including a selection to enable the user to access hospital cost and quality searching and various search options to enable the user to find a doctor, facility, pharmacy, and behavior health facility.

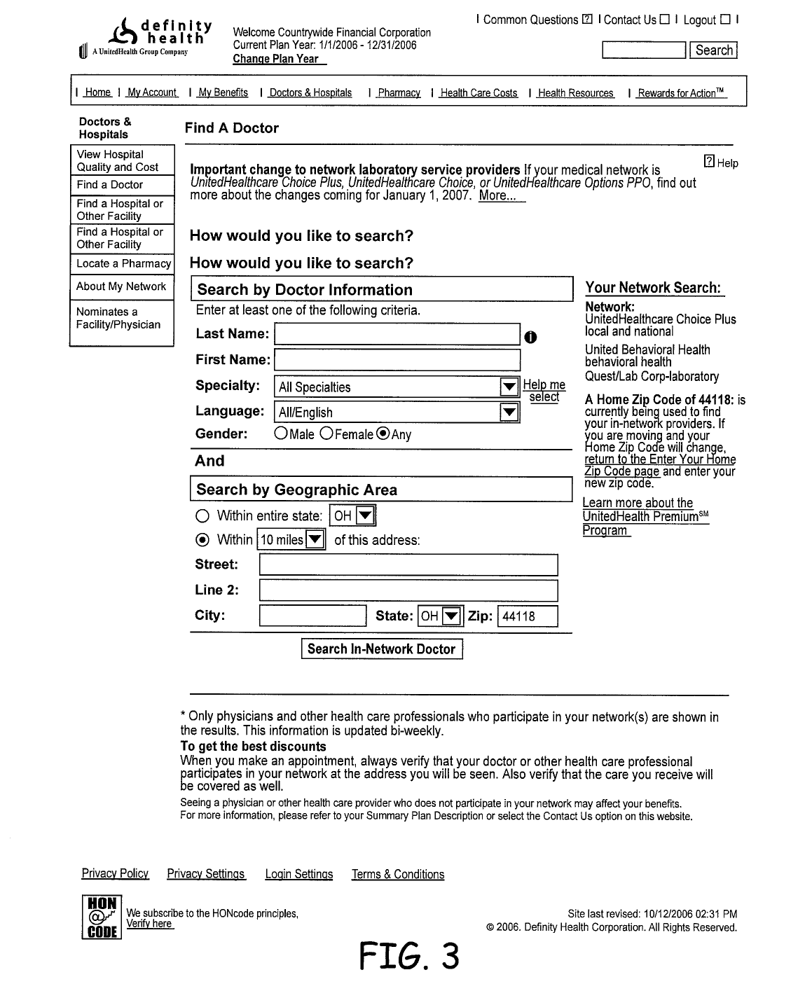

FIG. 3 depicts an exemplary screen shot of a web interface that may be displayed when a consumer selects the “find a doctor” link of FIG. 2 or FIG. 2A. According to FIG. 3, information that may be entered to facilitate a consumer's provider search may include provider information such as the provider's first and last name, specialty, spoken language(s), gender, and/or may include geographic area data such as affiliated facility location, state, and/or proximity to an address. Furthermore, the web interface of FIG. 3 may further include user selectable options to filter provider search results by the provider's quality and cost ratings (not shown).

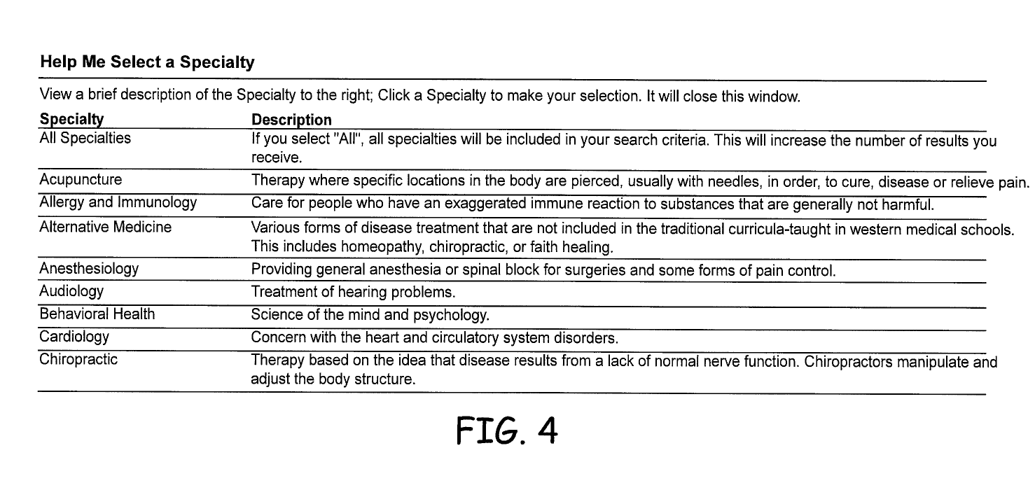

FIG. 4 depicts an exemplary screen shot of a web interface that provides a detailed description of provider specialties so that the consumer may accurately select a provider specialty when searching for a provider. The web interface displaying descriptions of provider specialties depicted in FIG. 4 may be displayed once the consumer selects a “Help me select” link on the provider search screen of FIG. 3, for example.

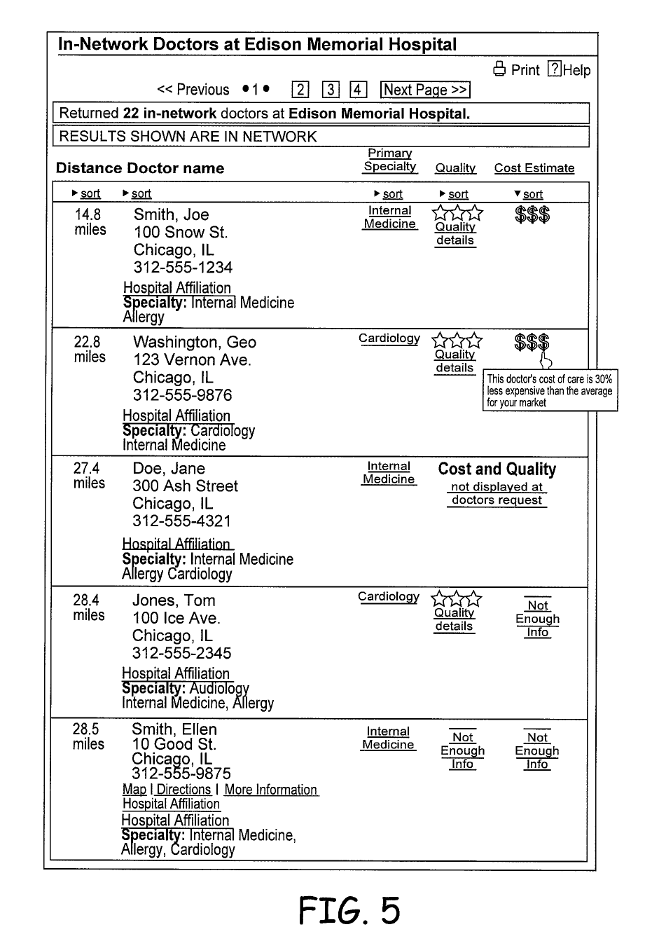

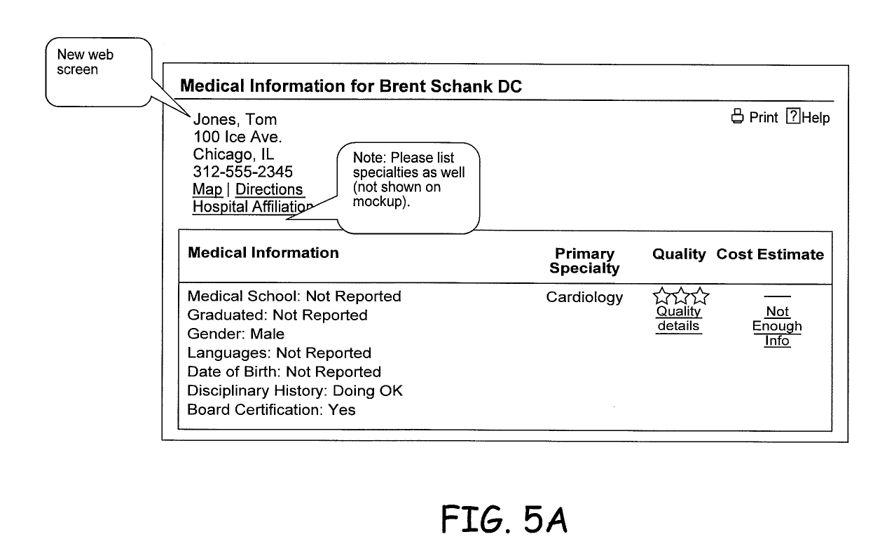

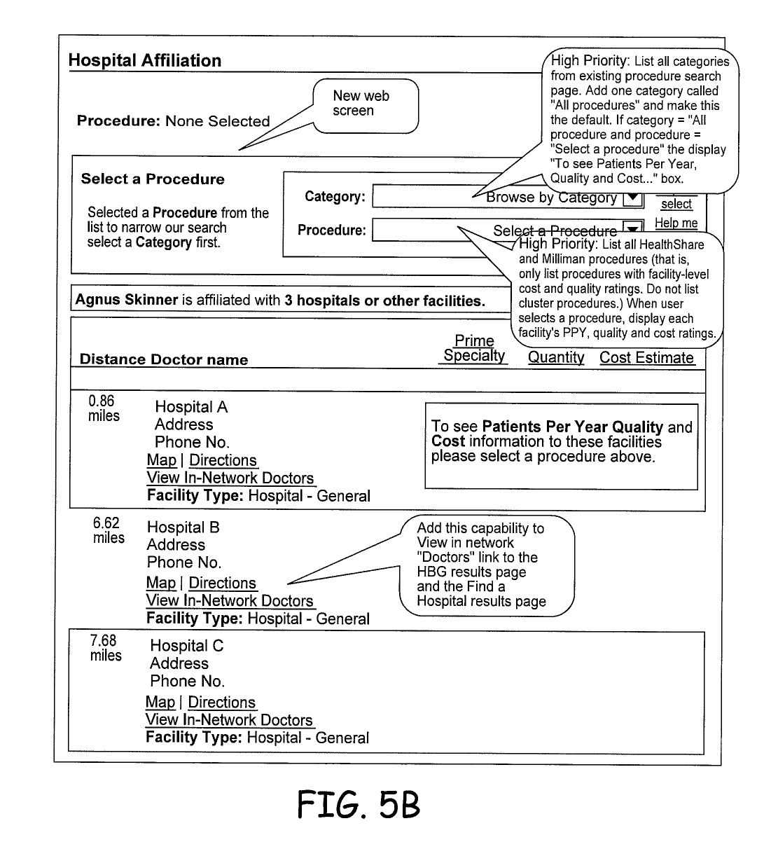

FIG. 5 depicts a screen shot of a web interface displaying an exemplary listing of results of a provider search. According to this example, the consumer enters the search criteria: in-network providers of all specialties at a selected hospital or other facility, and the screen shot of FIG. 5 displays all providers that are in-network and affiliated with the selected facility in order of the provider's office proximity to a user-entered address. However, the provider listing may alternatively be provided in alphabetical order, order of primary specialty, order of quality rating, and/or order of cost rating.

Provider-specific information that may be displayed in the search results web interface may include the provider's name and office location, specialty, cost rating, quality rating, and proximity to a user-entered address, if applicable. Additional links may also be provided with the provider specific information. For example, a consumer may select the provider's name and a listing of further details regarding the provider may be displayed such as average number of patients seen per year. A consumer also may select a provider's primary specialty to review a brief description of the specialty similar to the screen shot of FIG. 4. According to certain implementations, quality details such as the type of data used to calculate the quality rating may be viewed by selecting a “Quality details” link. In addition, details on a provider's cost rating may be viewed by the user by selecting the cost rating or by placing a cursor or pointer over the provider's cost rating. According to FIG. 5, for example, details on the cost rating for a selected provider may be displayed by placing the pointer over the provider's cost ratings, and the details indicate that the provider's cost of care is 30% less expensive than the average for the consumer's market. In FIG. 5, a provider's quality rating is displayed, if available. For example, the quality rating for Joe Smith is three stars, but the quality (and cost) rating for Jane, Doe is not displayed. For providers having insufficient data to rate for quality and cost, the web interface may display a message like “Not Enough Info.” where quality and/or cost data may normally be viewed. In some instances, “Not Enough Info.” may be a link that the consumer may select, and information may be provided such as why there is not enough information to rate the provider.

The screen shown in FIG. 5 may provide the user with a link to access additional information on each provider, such as schooling information, graduation date, birth date, languages spoken, any disciplinary history, and board certification information, for example, as shown in FIG. 5A. The screen of FIG. 5 may also provide a link to enable a user to obtain each provider's facility affiliations when the consumer selects a “hospital affiliation” link for a selected provider. The link generates a display, such as that shown in FIG. 5B, including each facility the provider is affiliated with, the facility's address, proximity to a consumer-entered address, if applicable, and links to a variety of information such as a map to the facility, directions to the facility, and a link listing of the in-network providers associated with the facility.

Furthermore, as illustrated in FIG. 5B, the user may select a procedure category, and in some instances a medical procedure, and the web interface displays information related to number of patients treated per year at the facility that fit in the category and/or procedure, the facility quality data related to the category and/or procedure, and the facility cost data related to the category and/or procedure. This may provide a consumer with facility quality and cost transparency for a specific medical category and/or procedure, which may enable the consumer to make an informed choice on where to receive a healthcare procedure, for example. In further implementations, category and/or procedure information may be selected for a particular provider and the number of patients the provider treats per year, the quality of care, and cost of care may be reviewed by the consumer in order to make a better-informed provider choice.

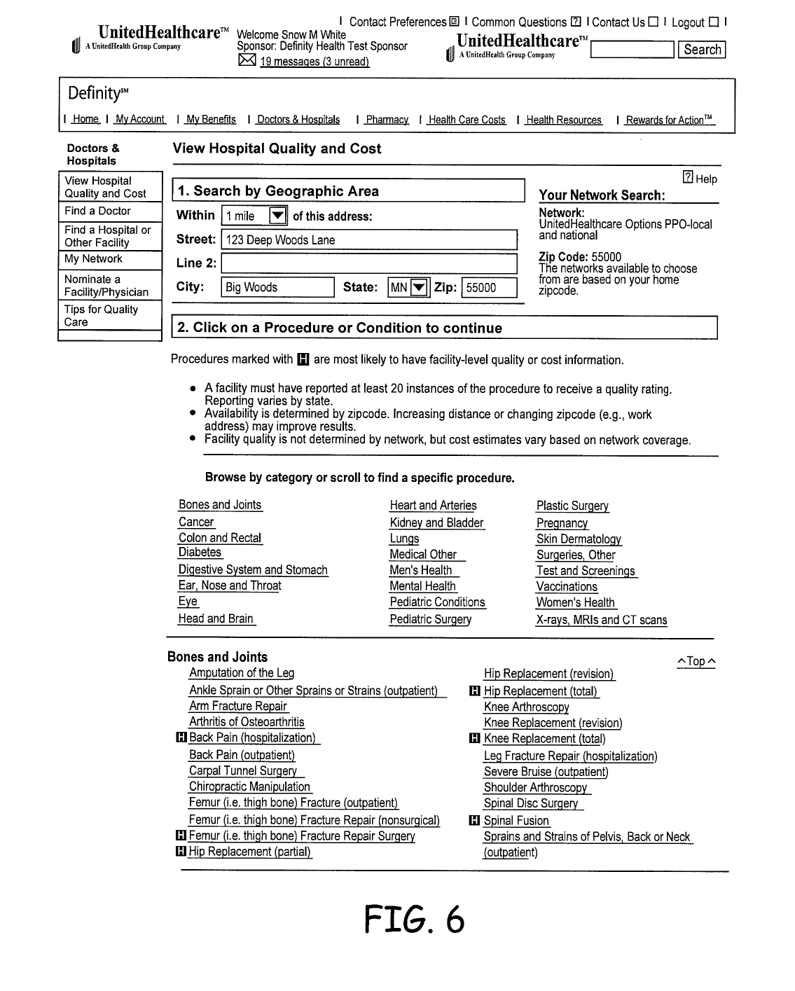

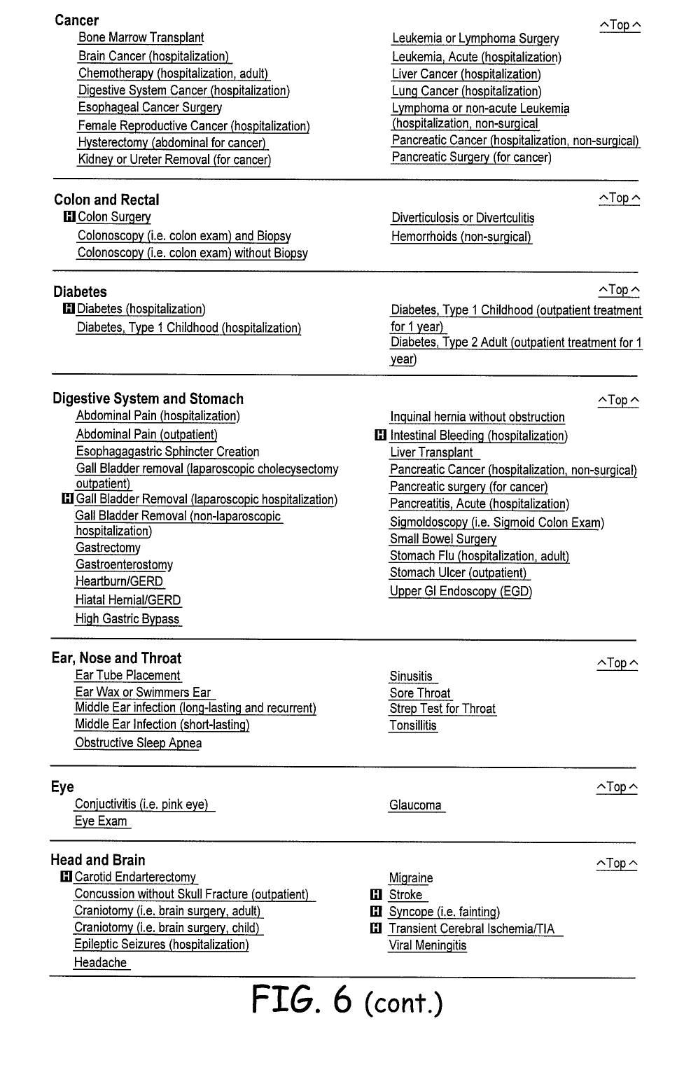

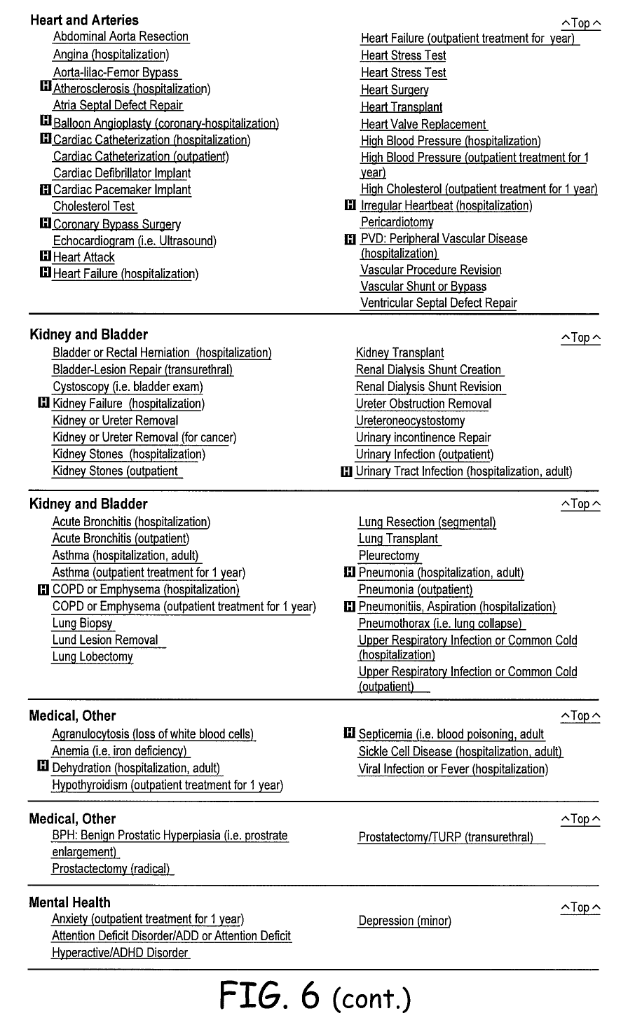

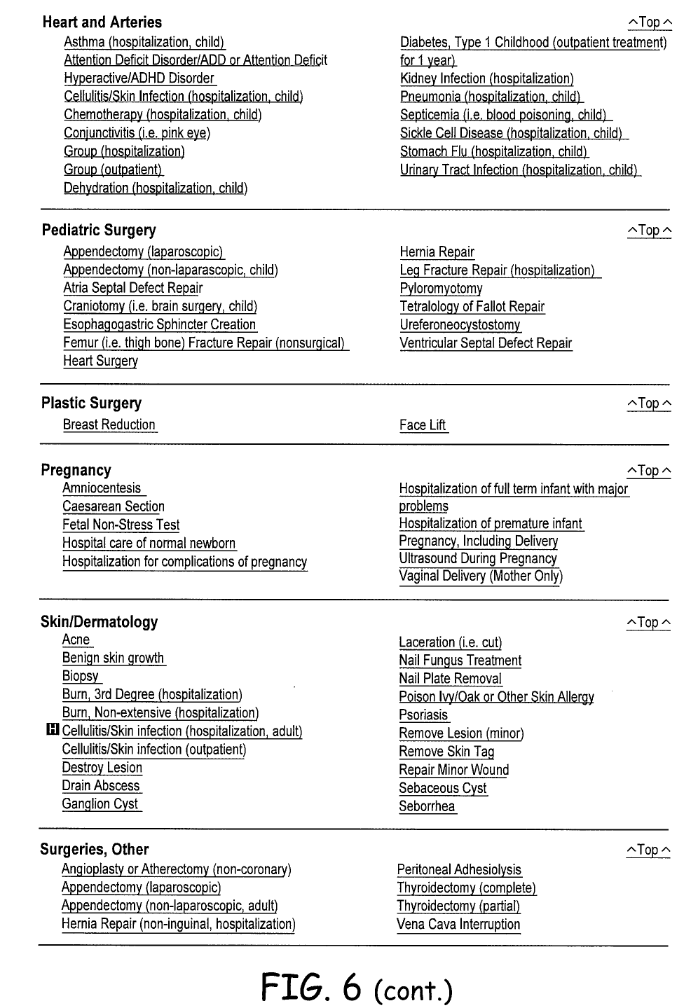

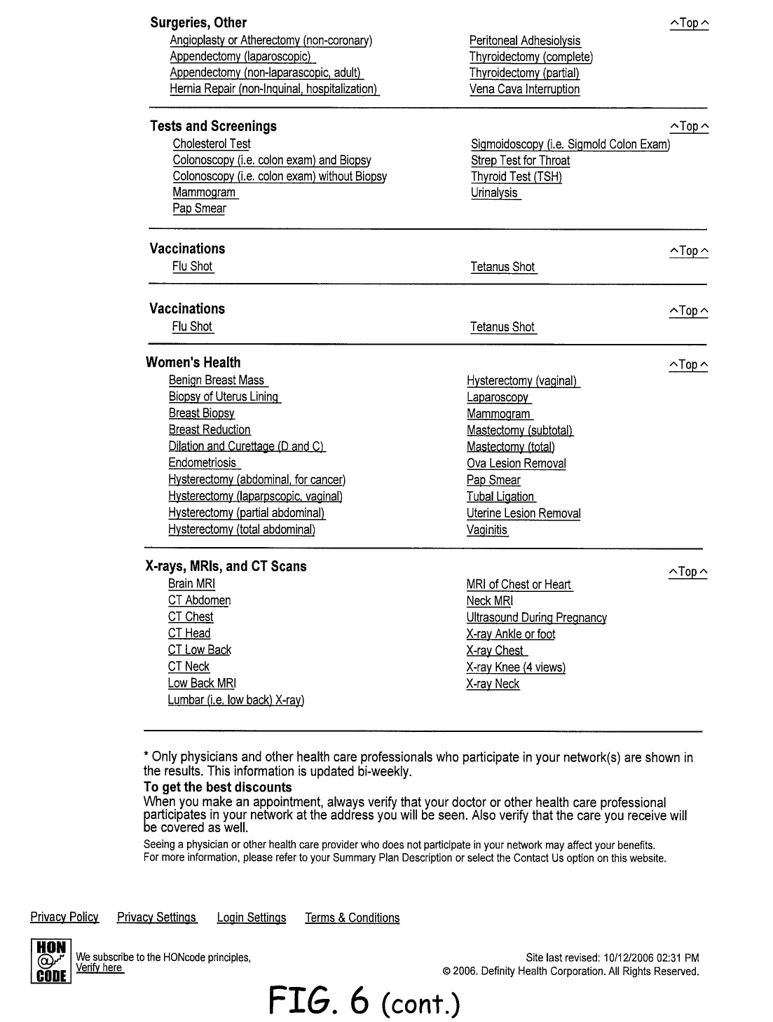

FIG. 6 depicts a screen shot of a search screen that enables a user to enter search criteria to view hospital quality and costs based upon a selected geographic area and selected procedure or service.

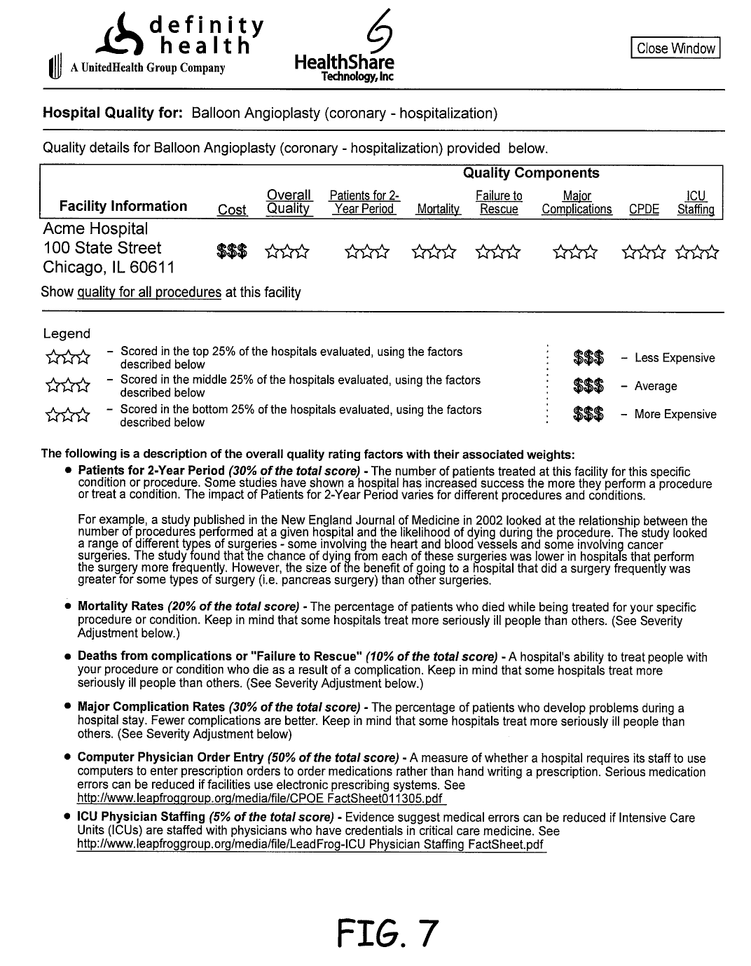

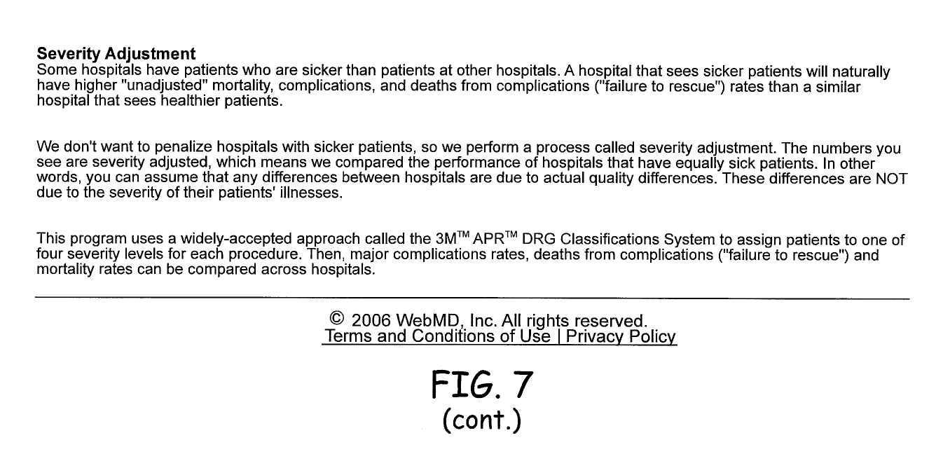

FIG. 7 depicts a screen shot of information displayed on a selected hospital, including a cost rating, an overall quality rating, and specific quality ratings for various quality components.

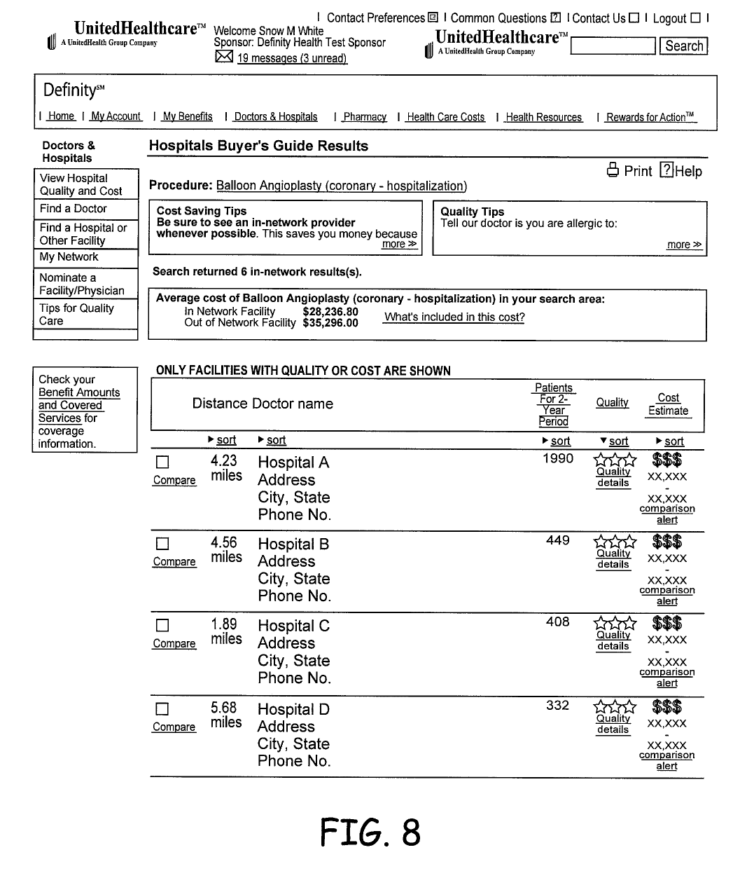

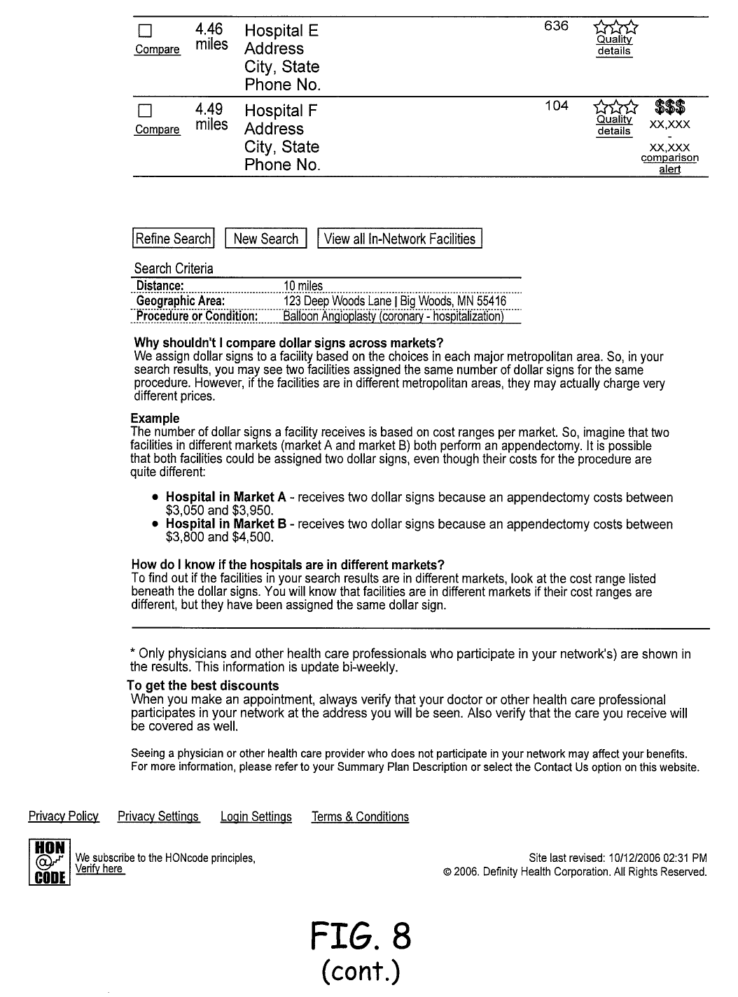

FIG. 8 depicts an exemplary screen shot of facility information displayed when a consumer selects a “Balloon Angioplasty (coronary—hospitalization)” procedure, for example, from a pull-down menu, such as the pull down menu shown in FIG. 5B. The web interface provides the consumer with information, if available, in the category of “Balloon Angioplasty (coronary—hospitalization)” for a number of hospitals and includes information such as the number patients seen at each hospital, the ranking of the quality of care provided to patients from each hospital, and the ranking of the cost of hospitalization. Specific cost ranges (dollar amounts) may also be provided. For example, FIG. 8 indicates the number of patients seen per year and the quality ranking for each of the hospitals listed and provides cost estimate rankings and cost ranges for each. Hospital information available to the consumer for “Balloon Angioplasty (coronary—hospitalization)” may further include links, such as a cost “comparison alert,” depicted in FIG. 8. In addition, average costs of a hospital stay for an in-network facility versus an out-of-network facility may also be provided.

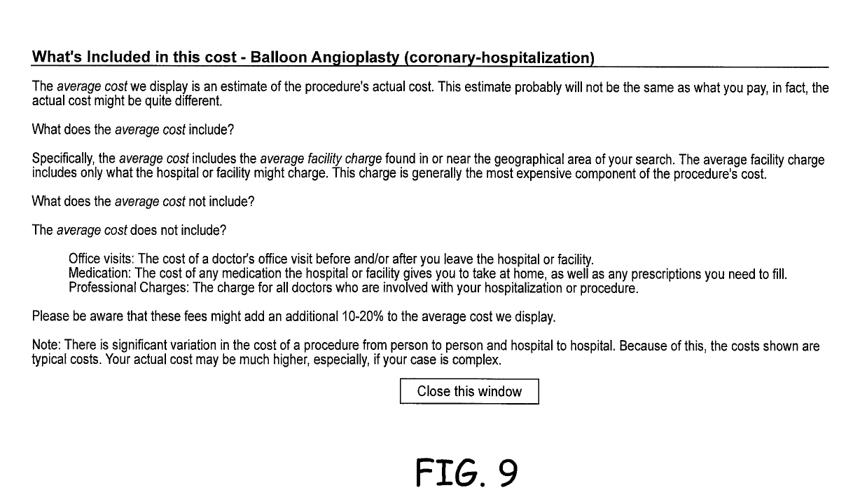

FIG. 9 depicts a screen shot of procedure specific cost information displayed when a consumer selects a link such as “What's included in this cost?”, for example, like the link depicted in FIG. 8 associated with to the average cost of “Balloon Angioplasty (coronary—hospitalization)”.

In certain alternatives, the consumer healthcare guide displays an average cost for a variety of procedures, regardless of whether procedure data is available in a given market. This may help consumers understand the cost they might expect to incur on average for a given procedure. According to this implementation, the average cost for a heart failure for an in-network facility and an out-of-network facility may be provided on a web interface where there are no actual facility specific costs, i.e., no specific facility has associated average cost data, for the procedure in a given market. This may be the case when facilities in a given market have not treated enough patients for a condition to be analyzed. For example, if less than 20 patients have been treated for a condition at each facility in a given market, then an average cost calculation may be unreliable and/or unavailable. In this case, the displayed data associated with the facility may include the number of patients treated with the condition.

FIGS. 2-9 depict screen shots related to a consumer healthcare guide that provides provider and facility information. However, a consumer healthcare guide providing facility cost and quality data may be provided without provider information.

The method and system according to the present invention may be implemented using various combinations of software and hardware as would be apparent to those of skill in the art and as desired by the user. The present invention may be implemented in conjunction with a general purpose or dedicated computer system having a processor and memory components.

From the above description and drawings, it will be understood by those of ordinary skill in the art that the particular implementations shown and described are for purposes of illustration only and are not intended to limit the scope of the present invention. Those of ordinary skill in the art will recognize that the present invention may be embodied in other specific forms without departing from its spirit or essential characteristics. References to details of particular implementations are not intended to limit the scope of the invention.

What is claimed is:

1. A method for providing a consumer healthcare guide comprising:
receiving a set of search criteria; and
retrieving one or more health-related listings based on said set of search criteria, wherein at least one of the health-related listings comprises consumer cost data.

2. The method of claim 1, wherein the one or more health-related listings comprises provider listings.

3. The method of claim 2, wherein the consumer cost data for the provider listings comprises a consumer cost rating based upon provider costs associated with a selected healthcare product or service.

4. The method of claim 1, wherein the one or more health-related listings comprises facility listings.

5. The method of claim 4, wherein the consumer cost data for the facility listings comprises a consumer cost rating based upon facility charges associated with a selected healthcare product or service.

6. The method of claim 1, wherein the set of search criteria comprises search data for a geographic area.

7. The method of claim 6, further comprising providing an average cost associated with the health-related listing for the geographic area.

8. The method of claim 1, wherein the consumer cost data comprises a cost rating, the cost rating being one of a plurality of cost ratings, each of said cost ratings corresponding to a predetermined cost estimate range.

9. The method of claim 1, wherein at least one of the health-related listings further comprises quality data associated with the health-related listing.

10. The method of claim 9, wherein the quality data comprises a quality rating, the quality rating being one of a plurality of quality ratings, each of said quality ratings corresponding to a predetermined quality score range.

11. A method for providing a consumer healthcare guide comprising:
receiving a set of search criteria; and
retrieving one or more health-related listings based on said set of search criteria, wherein at least one of the health-related listings comprises health-related listing quality data.

12. A system for providing a consumer healthcare guide comprising:
data storage for storing health-related data; and
a processor for:
receiving a set of search criteria; and
retrieving one or more health-related listings based on said set of search criteria, wherein at least one of the health-related listings comprises associated consumer cost data.

13. The system of claim 12, wherein retrieving one or more health related listings comprises retrieving one or more provider listings.

14. The system of claim 13, wherein the consumer cost data for the provider listings comprises a consumer cost rating based upon provider costs associated with a selected healthcare product or service.

15. The system of claim 12, wherein retrieving one or more health related listings comprises retrieving one or more facility listings.

16. The system of claim 15, wherein the consumer cost data for the facility listings comprises a consumer cost rating based upon facility charges related to a medical procedure.

17. The system of claim 12, wherein a portion of the set of search criteria received comprises search data for a geographic area.

18. The system of claim 12, wherein the consumer cost data comprises a cost rating, the cost rating corresponding to a cost estimate falling within a predetermined range for the cost rating.

19. The system of claim 12, wherein at least one of the health-related listings comprises quality data associated with the health-related listing.

20. The system of claim 19, wherein the quality data comprises a quality rating corresponding to a quality score based on predetermined criteria.

21. The system of claim 12, further comprising providing the retrieved data on a graphical user interface.

22. A system for providing a consumer healthcare guide comprising:
data storage for storing provider data relating to a plurality of healthcare providers; and
a processor for:
generating provider rating data including a quality rating and a cost rating for each of the plurality of healthcare providers, wherein the provider rating data is generated using the stored provider data;
receiving search criteria input by a user; and
providing selected provider rating data based upon the search criteria input by the user.

23. A system for providing a consumer healthcare guide comprising:
data storage for storing facility data relating to a plurality of healthcare facilities; and
a processor for:
generating facility rating data including a quality rating and a cost rating for each of the plurality of healthcare facilities, wherein the facility rating data is generated using the stored facility data;
receiving search criteria input by a user; and
providing selected facility rating data based upon the search criteria input by the user.
